(19) United States
(12) Patent Application Publication
(10) Pub. No.: US 2004/0007578 A1
(43) Pub. Date: Jan. 15, 2004

(54) Paintbrush draining container

(76) Inventor: Dayton Eugene Richards, Bluff City, TN (US)

Correspondence Address: Susan F. Johnston, Attorney at Law, P.O. Box 4449, Johnson City, TN, 37602-4449, US

(21) Appl. No.: 10/617,564

(22) Filed: Jul. 11, 2003

Related U.S. Application Data
(60) Provisional application No. 60/395,223, filed on Jul. 11, 2002.

(51) Int. Cl. B05C 21/00

(52) U.S. Cl. 220/570

(57) ABSTRACT

The present invention is a container for draining a liquid from a wet, tapered paintbrush so that the bristles do not deleteriously flair upon drying. The single-piece container includes a draining sleeve section and a catch pan section. The draining sleeve has an open upper sleeve end and an open or partially-open lower sleeve end. The panels of the draining sleeve form a wedge-shaped drainage channel therebetween, corresponding to the tapered shape of the bristle end of the paintbrush.

### CROSS REFERENCES TO RELATED APPLICATIONS

This application claims the benefit of U.S. Provisional Application Serial No. 60/395,223 filed Jul. 11, 2002.

### FIELD OF THE INVENTION

The present invention is in the field of painting devices and supplies. More particularly, the present invention is a container useful for draining paint or a paint solvent from a wet, tapered paintbrush.

### BACKGROUND

Painters strive to maintain their paintbrushes so that the bristle end of a brush remains in its original shape as long as possible. Brush bristle maintenance is especially important for tapered paintbrushes intended for use in painting trim and intricate designs. One common problem is that brush bristles tend to deleteriously flair when a brush that is wet with paint or pain solvent is allowed to dry.

It is an object of the present invention to provide an apparatus useful for maintaining the original shape of the bristle end of a tapered paintbrush. It is a further object of the present invention for such apparatus to be convenient to use while painting, particularly for painting substrates requiring painter mobility, such as walls and wall trim. It is a still further object of the present invention to provide an apparatus that is useful for maintaining the shape of a variety of sizes and shapes of tapered paintbrushes.

### BRIEF DESCRIPTION OF THE DRAWINGS

FIG. 1 is a perspective view showing a preferred embodiment of the present paintbrush draining container wherein the catch pan also serves as a paint roller pan.

FIG. 2 is a detail perspective view of the preferred container of the present invention.

### SUMMARY OF THE INVENTION

The present invention is a container for draining a liquid from a wet, tapered paintbrush. The container includes a draining sleeve and a catch pan. The draining sleeve 20 has an open upper sleeve end 36 and an open or partially-open lower sleeve end 32, a front panel 30, a rear panel 28, and a pair of opposite side panels 24. The rear panel and the pair of opposite side panels extend downwardly from the open lower sleeve end 32 to a catch pan 22. The catch pan that defines an open reservoir 34 adapted for collecting the drained liquid. The panels of the draining sleeve form a wedge-shaped drainage channel 38 therebetween. The wedge-shaped channel has a size suitable for receiving the bristle end of the tapered paintbrush and holding the bristles a compact, tapered manner.

### DETAILED DESCRIPTION

The present invention is a container for draining a liquid, such as paint or a paint solvent, from a wet, tapered paintbrush. The container includes a first section for holding and draining the paintbrush, referred to herein as the draining sleeve. The container further includes a second section for collecting the liquid, referred to herein as the catch pan.

Referring to FIG.'S 1-2, the draining sleeve 20 of the container has an open upper sleeve end 36 and an open or partially-open lower sleeve end 32, a front panel 30, a rear panel 28, and a pair of opposite side panels 24. The rear panel and the pair of opposite side panels extend downwardly from the lower sleeve end 32 to the catch pan 22. The catch pan defines an open reservoir 34 adapted for collecting the drained liquid.

It is an important aspect of the present invention that the front and rear panels of the draining sleeve are aligned with each other in a sufficiently downwardly converging direction to form a wedge-shaped drainage channel 38 between the panels. The angle of convergence of the draining sleeve is suitable to define a channel therein that is wide enough at the upper sleeve end to receive the bristle end of the tapered paintbrush, yet narrow enough at the lower sleeve end to secure the bristles in a compact, tapered manner so as to prevent flaring as the bristles become dry. The angle formed by the direction of the front panel and the rear panel preferably converges at a point no lower than the bottom of the catch pan reservoir.

The lower sleeve end 32 may be either completely open or partially open. FIG.'S 1-2 show a partially open lower sleeve end provided by a front panel 30 having two orifices 40 in the lower portion thereof. The wedge-shaped cavity 38 may have a single drainage orifice 40 or a plurality of orifices, as long as it is sufficiently open to allow for drainage.

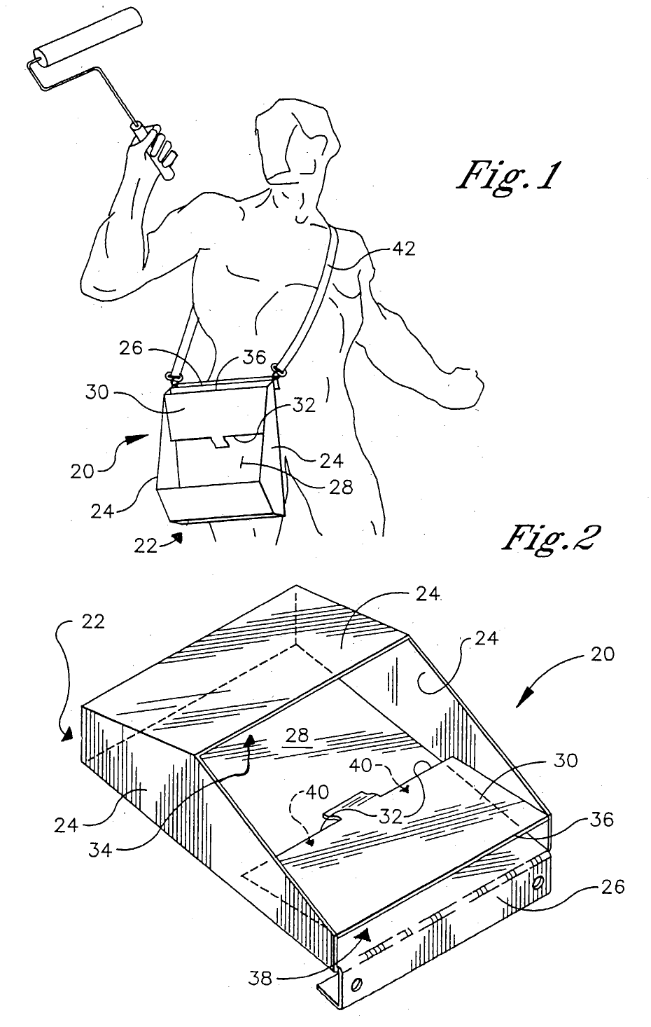

In the preferred embodiment of the present invention, the catch pan of the draining container is adapted for use as a paint roller pan, as shown in the Figures. Thus, the draining container can be used for draining a tapered paint brush at the same time that it is being used as a rolling pan. The drainage container of the present invention can be usable in an upright position as a stand-alone container. Alternatively, the container can be equipped with a means for hanging the container from an object such as a ladder, window sill, or from a painter's body, as shown in FIG. 1. Suitable means for hanging include a hook 26 as shown in FIG. 2, a strap 42 as shown in FIG. 1, and traditional affixing mechanisms. The container can also be a modified paint roller pan for lateral use, as shown in FIG. 2. Various additional applications of the invention should become evident to one of ordinary skill in the art from the Figures.

The draining container of the present invention can be formed from any nonporous material. Particularly suitable materials include plastics and lightweight metals such as aluminum. Methods of manufacture include traditional methods such as injection molding, thermoforming, and stamping.

The invention has been described in detail with particular reference to preferred embodiments thereof, but it will be understood that variations and modifications can be effected within the spirit and scope of the invention.

I claim:

1. A container for draining a liquid from a wet, tapered paintbrush a having a handle end and a bristle end, said container comprising:
a draining sleeve and a catch pan, said draining sleeve having an open upper sleeve end and an open lower sleeve end, a front panel, a rear panel, and a pair of opposite side panels, said rear panel and said pair of opposite side panels extending downwardly from said open lower sleeve end to said catch pan, said catch pan defining an open reservoir adapted for collecting the drained liquid,
wherein said front panel and said rear panel downwardly extend from said open upper sleeve end to said open lower sleeve end in converging directions forming an angle intersecting below said draining sleeve and thereby defining a wedge-shaped drainage channel therebetween that is adapted for receiving the bristle end of the tapered paintbrush.

2. The container according to claim 1 wherein said drainage channel has a lower end sufficiently small to secure the bristle end of the paintbrush in a compact manner.

3. The container according to claim 1 wherein the angle formed by the direction of said front panel and said lower panel converges at a position no lower than said reservoir.

4. The container according to claim 1 wherein said reservoir is adapted to receive a point roller therein.

5. The container according to claim 4 wherein said container is a modified paint roller pan.

6. The container according to claim 1 further comprising a means for hanging said container from an object in a upright position.

7. A container for draining a liquid from a wet, tapered paintbrush having a handle end and a bristle end, said container comprising:
a draining sleeve having a front panel, a rear panel, and a pair of opposite side panels extending from an open upper sleeve end to a lower sleeve end, said front panel defining a an orifice at said lower sleeve end suitable for providing drainage of the liquid, said rear panel and said pair of opposite side panels extending downwardly from said lower sleeve end to a catch pan defining an open reservoir adapted for collecting the drained liquid,
wherein said front panel and said rear panel downwardly extend from said upper sleeve end to said lower sleeve end in converging directions forming an angle intersecting below said draining sleeve and defining a wedge-shaped drainage channel therebetween that is adapted for receiving the bristle end of the tapered paintbrush.

8. The container according to claim 7 wherein said drainage channel has a lower end sufficiently small to secure the bristle end of the paintbrush in a compact manner.

9. The container according to claim 7 wherein said front panel defines a plurality of orifices at said lower sleeve end.

10. The container according to claim 7 wherein said reservoir is adapted to receive a point roller therein.

11. The container according to claim 10 wherein said container is a modified paint roller pan.
